(19) United States
(12) Patent Application Publication
(10) Pub. No.: US 2011/0059692 A1
(43) Pub. Date: Mar. 10, 2011

(54) COMMUNICATIONS DEVICE USING NEAR FIELD

(75) Inventors: Chang Hee Hyoung, Daejeon (KR); Sung Weon Kang, Daejeon (KR); In Gi Lim, Daejeon (KR); Hyung Il Park, Daejeon (KR); Tae Wook Kang, Daejeon (KR); Jung Hwan Hwang, Daejeon (KR); Kyung Soo Kim, Daejeon (KR); Jung Bum Kim, Daejeon (KR); Sung Eun Kim, Seoul (KR); Seok Bong Hyun, Daejeon (KR); Kyung Hwan Park, Daejeon (KR); Byoung Gun Choi, Daegu (KR); Tae Young Kang, Daejeon (KR)

(73) Assignee: Electronics and Telecommunications Research Institute, Daejeon (KR)

(21) Appl. No.: 12/877,067

(22) Filed: Sep. 7, 2010

(30) Foreign Application Priority Data
Sep. 8, 2009 (KR) 10-2009-0084344
Aug. 27, 2010 (KR) 10-2010-0083628

(51) Int. Cl. H04B 5/00

(52) U.S. Cl. 455/41.1

(57) ABSTRACT

A communications device using a near field includes: a near field signal providing unit providing one of a baseband signal and a signal obtained by applying digital modulation to the baseband signal, as a near field signal; an interface unit transmitting and receiving the provided near field signal; and a controller controlling the near field signal providing unit and the interface unit. A low data transfer rate of the related art near field communications can be overcome. Namely, various services can be provided by using a high data transfer rate. In particular, near field communications and a network configuration and data communications performed through the existing wireless network can be implemented as a single combined technique. In addition, power supply and communications can be simultaneously provided effectively by sharing an interface of an electrical coupling and a magnetic coupling.

### CROSS-REFERENCE TO RELATED APPLICATIONS

This application claims the priority of Korean Patent Application Nos. 10-2009-0084344 filed on Sep. 8, 2009 and 10-2010-0083628 filed on Aug. 27, 2010, in the Korean Intellectual Property Office, the disclosure of which is incorporated herein by reference.

### BACKGROUND OF THE INVENTION

1. Field of the Invention

The present invention relates to a communications device using a near field and, more particularly, to a communications device using a near field capable of supporting a higher data transmission rate.

2. Description of the Related Art

Near field communications (NEC) is a technique of transmitting data at a rate of about 424 kbps with low power consumption at a distance within 10 centimeters, based on RFID using the frequency band of 13.56 MHz.

According to the NFC technique, two or more NFC supporting terminals can perform bi-directional communications, such as transmitting and receiving an address list, games, MP3 files, and the like, as well as phone numbers, by simply allowing the terminals to come into close proximity without any intentional manipulation by users.

The NFC technique enables mobile phones, AV equipment, digital cameras, PDAs, set-top boxes (STBs), and computers, to access each other by intuition to easily move or operate various contents, and provides automatic network setting of the already existing Bluetooth™ and wireless 802.11 equipment.

However, although the NFC supports operations at low power consumption, it is disadvantageous in that a data transfer rate is low.

### SUMMARY OF THE INVENTION

An aspect of the present invention provides a communications device using near field communications (NFC) capable of supporting a high data transfer rate.

According to an aspect of the present invention, there is provided a communications device using a near field, including: a near field signal providing unit providing one of a baseband signal and a signal obtained by applying digital modulation to the baseband signal, as a near field signal; an interface unit transmitting and receiving the provided near field signal; and a controller controlling the near field signal providing unit and the interface unit.

The near field signal providing unit may not apply a modulation scheme using a carrier to one of the baseband signal and the signal obtained by applying digital modulation to the baseband signal.

The near field signal providing unit may include a filter for limiting the frequency band of one of the baseband signal and the signal obtained by applying digital modulation to the baseband signal.

The interface unit may include: an antenna transmitting and receiving a radio signal therethrough and a matching circuit.

The interface unit may further include: an insulating layer protecting at least one of the antenna and the matching circuit.

The interface unit may be formed as a transparent electrode.

The device may further include: a display unit visually displaying information regarding the communications device using a near field.

The display unit may visually display an external device available for communications.

The display unit may share a component with the interface unit.

The device may further include: an external communications unit providing a communications scheme other than communications using a near field.

The external communications unit may use one of a wired communications scheme and a wireless communications scheme.

The wired communications scheme of the external communications unit may be at least one of a USB, a LAN, and serial communications.

The wireless communications scheme of the external communications unit may be at least one of a WLAN, ZigBee™, RFID, and Bluetooth™.

The device may further include: an induced voltage generation unit supplying power required for the communications device using a near field.

The induced voltage generation unit may receive power from an external power source device and provide an induced voltage to a different communications device using a near field.

The induced voltage generation unit may receive an induced voltage from a different communications device using a near field.

The device may further include: a battery unit storing power required for the communications device using the near field.

The controller may include a memory for storing control information regarding the near field signal providing unit and the interface unit.

The controller may perform authentication for communications using the near field.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a communications device using a near field according to an exemplary embodiment of the present invention;

FIG. 2 is a schematic block diagram of a communications device using a near field according to another exemplary embodiment of the present invention;

FIG. 3 is a view for explaining a service using a communications device using a near field according to an exemplary embodiment of the present invention;

FIG. 4 is a view for explaining a service using a communications device using a near field by employing an external communications unit according to a wired communications scheme according to an exemplary embodiment of the present invention; and

FIG. 5 is a view for explaining a service using a communications device using a near field by employing an external communications unit according to a wireless communications scheme according to an exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined in the present application.

Embodiments of the present invention will be described below in detail with reference to the accompanying drawings, where those components are rendered the same reference number that are the same or are in correspondence, regardless of the figure number, and redundant explanations are omitted.

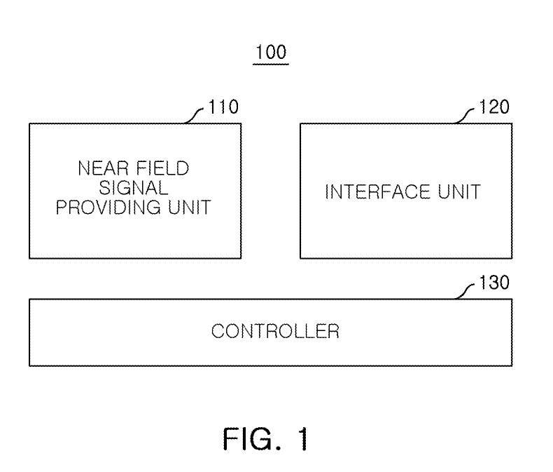

FIG. 1 is a schematic block diagram of a communications device using a near field according to an exemplary embodiment of the present invention.

With reference to FIG. 1, a communications device 100 using a near field according to an exemplary embodiment of the present invention includes a near field signal providing unit 110 providing one of a baseband signal and a signal obtained by applying digital modulation to the baseband signal, as a near field signal, an interface unit 120 transmitting and receiving the provided near field signal, and a controller 130 controlling the near field signal providing unit and the interface unit.

The communications device 100 using a near field according to an exemplary embodiment of the present invention uses a digital near field communications (NEC) technique based on a scheme in which a baseband signal or a signal obtained by applying digital modulation to the baseband signal is transmitted and a received signal is restored, rather than based on a frequency modulation scheme using a carrier, as a method for transferring high speed data.

Services using high speed data transmission characteristics as well as low speed data transmission characteristics can be provided by using the digital NFC technique.

The near field signal providing unit 110 may provide one of a baseband signal and a signal obtained by applying digital modulation to the baseband signal, as a near field signal.

Also, the near field signal providing unit 110 may not apply a modulation scheme using a carrier to one of the baseband signal and signal obtained by applying digital modulation to the baseband signal.

In other words, the signal may include a signal such as a TTL or CMOS level in which 0 and 1 used for logic are indicated as a voltage value, and such signal may be generated through a digital logic circuit. Modulation through the digital logic circuit includes a spreading operation, and because the generated digital signal has broadband frequency characteristics, a filter may be configured to limit the band. Information is received, undergoes a spreading modulation process through the digital logic circuit, and then passes through a filter. The resultant signal then communicates with an adjacent device through an interface.

Namely, because the near field signal providing unit 110 does not use the frequency continuous modulation scheme used for the conventional near field communications, it does not require a carrier. Thus, a higher data transfer rate can be secured, and a near field signal generated by the near field signal providing unit 110 can communicate with a device through the interface unit 120.

Also, the near field signal providing unit 110 may include a filter for limiting a frequency band of one of the baseband signal and signal obtained by applying digital modulation to the baseband signal.

The interface unit 120 may include an antenna transmitting and receiving a radio signal therethrough to better transfer signals between contiguous devices or adjacent devices, and a matching circuit required for the antenna. The interface unit 120 may be configured as an electrode based on a contact scheme.

The interface unit 120 may be made of a material having conductivity, installed at an inner side of a mechanism of the device, and exposed for user convenience. When the interface unit 120 is exposed, it may further include an insulating layer for protecting at least one of the antenna and the matching circuit in order to ensure user safety and protect the device.

Also, the interface unit 120 may be configured as a transparent electrode, and in this case, the transparent electrode may have a certain pattern to improve signal transmission characteristics.

The controller 130 may control the near field signal providing unit 110 and the interface unit 120.

Namely, the controller 130 generally performs controlling operations required for the communications device 100 using a near field. The controller 130 may control the near field signal providing unit 110 and the interface unit 120, and also control a display unit 140, an external communications unit 150, an induced voltage generation unit 160, and a battery unit 170.

In addition, the controller 130 may include a memory for storing control information with respect to the near field signal providing unit 110 and the interface unit 120 or may perform authentication for communications using the near field.

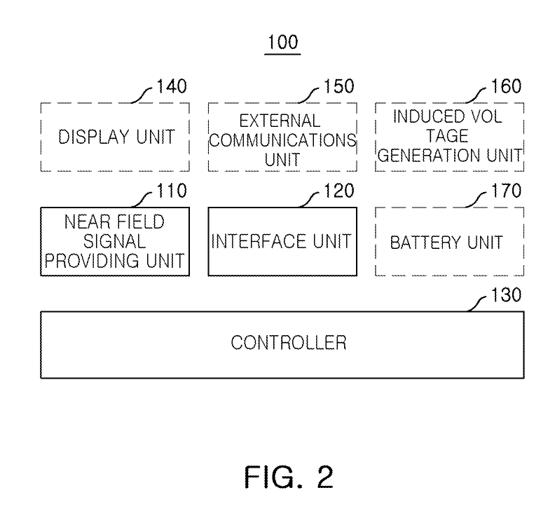

FIG. 2 is a schematic block diagram of a communications device using a near field according to another exemplary embodiment of the present invention.

With reference to FIG. 2, the communications device 100 using a near field according to another exemplary embodiment of the present invention may further include the display unit 140 visually displaying information regarding the communications device using the near field.

The display unit 140 may visually display an external device available for communications and may share components with the interface unit 120.

For example, in a device having the display unit 140, the interface unit 120 made of a transparent material having conductivity may exist on the surface of the display unit 140 to provide an intuitive service to users.

An insulating layer may be formed on the interface unit 120 present on the surface of the display unit 140. Also, a conductive film required to configure the display unit 140 may be used as the interface unit 120.

In configuring a general flat panel display device, the principle that a plurality of horizontal transparent electrodes and a plurality of vertical transparent electrodes are formed and signals are transmitted to the pertinent transparent electrodes to illuminate cells at the corresponding positions is used to display image information, and the transparent electrode used in this case may be used as the interface unit 120 of the near field communications.

The display unit 140 having a function for recognizing a user's contact and an input pattern includes a transparent conductive layer formed on an image display device to recognize a contact, and in this case, the interface unit 120 may be configured to recognize a contact by using the layer and transmit a digital signal through a transparent electrode of the recognized contact.

When an icon, a button, and the like, of the display unit 140 is in use for near field communications, a plurality of small electrodes existing in the display unit 140 may be used as an antenna pattern of the interface unit 120.

With reference to FIG. 2, the communications device 100 using a near field according to another exemplary embodiment of the present invention may further include the external communications unit 150 providing a communications scheme other than the communications using a near field. The external communications unit 150 may use at least one of a wired communications scheme and a wireless communications scheme. When the external communications unit 150 uses a wired communications scheme, it may use at least one of a USB, a LAN and serial communications, and when the external communications unit 150 uses a wireless communications scheme, it may use at least one of a WLAN, ZigBee™, RFID, and Bluetooth™.

With reference to FIG. 2, the communications device 100 using a near field according to another exemplary embodiment of the present invention may further include the induced voltage generation unit 160 providing power required for the communications device 100 using a near field.

The induced voltage generation unit 160 is charged with power upon receiving it from an external power source device, and provides an induced voltage to a different communications device using a near field.

In general, the NFC technique is a technique for transmitting and receiving high speed data between contiguous devices or adjacent devices, so there may be a situation in which communications are performed for a long period of time between devices according to a usage field. In this case, the communications device using a near field that can operate for a long period of time upon receiving power from the external power source device will be required.

The induced voltage generation unit 160 may receive an induced voltage from a different communications device using a near field.

For the reasons mentioned above, if a communications device using a near field cannot be directly provided with power from an external power source device, it should receive an induced voltage from an external communications device using a near field.

For example, a first communications device using a near field, which directly receives power from the external power source device, can operate with the external power and generates induced power by an induced magnetic field by using the received external power.

Meanwhile, a second communications device using a near field, which cannot directly receive power from the external power source device, may use second induced power induced by the first induced power generated from the first communications device using a near field.

As a result, a portion of the power supplied from one external power source device may be directly used by the first communications device using a near field, and the remnant may be used when the first communications device using a near field generates the first induced power to generate the second induced power for the second communications device using a near field. Namely, the remaining power may be used for the operation of the second communications device using a near field.

Also, an interface may be utilized to support both power supply and communications as required. The communications device using a near field uses electrical coupling characteristics and uses magnetic coupling characteristics for power supply, so the use of the interface may be shared for the two different couplings as necessary, thus reducing the volume, area, and the like.

With reference to FIG. 2, the communications device 100 using a near field according to another exemplary embodiment of the present invention may further include the battery unit 170 storing power required for the communications device 100 using a near field.

In case in which power supply from the external power source device is suspended or cut, the communications device 100 using a near field preferably needs to operate, so the battery unit 170 storing power required for the operation of the communications device 100 using a near field would be required.

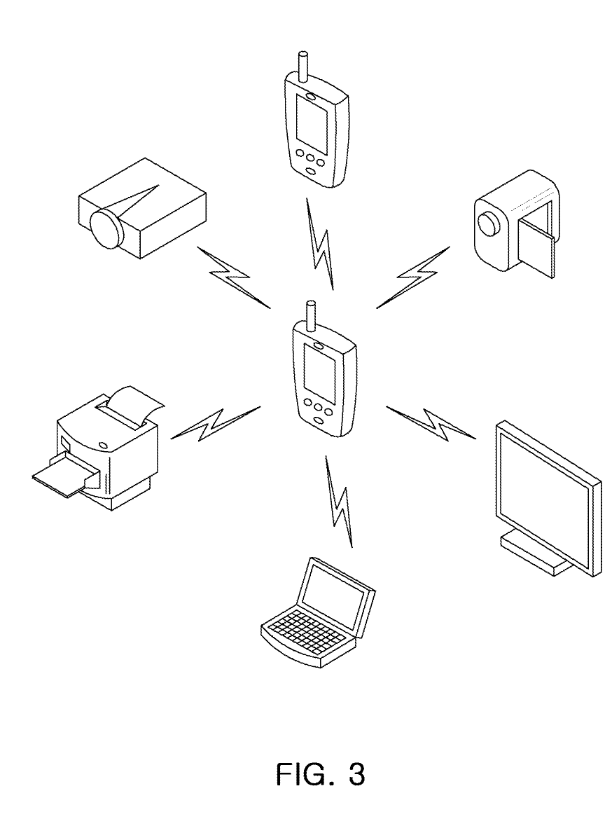

FIG. 3 is a view for explaining a service using a communications device using a near field according to an exemplary embodiment of the present invention.

With reference to FIG. 3, services using the communications device using a near field according to an exemplary embodiment of the present invention include diverse services such as a low speed data transmission service or a high speed data transmission service by configuring a network between electronic devices existing around in a contact or proximity manner, such as between mobile phones, between a mobile phone and a peripheral device, between notebook computers, and the like.

Unlike the conventional NFC, data communications are performed by using a baseband signal or a digital signal obtained through a digital modulation process, without using a frequency modulation scheme, and data can be transmitted at high speed between two devices.

Through the high speed data transmission, music files or video files, as well as a simple electronic business name card, may be transmitted between mobile phones, and image information stored in a mobile phone may be output to a beam projector or an external monitor.

In addition, personalized or synchronized content may be directly transmitted between contiguous or adjacent devices by providing a network between terminals, notebook computers, or personal computers (PCs).

A user's mobile device is configured to have a small screen in consideration of its portability. Even an extended display device such as a notebook computer may need to perform outputting to a beam projector or an external extended display device according to circumstances. In this case, the external display device may be utilized as a multi-monitor of the user through the communications device using a near field. The external display may display the same or different information as that of the screen of the user's mobile device.

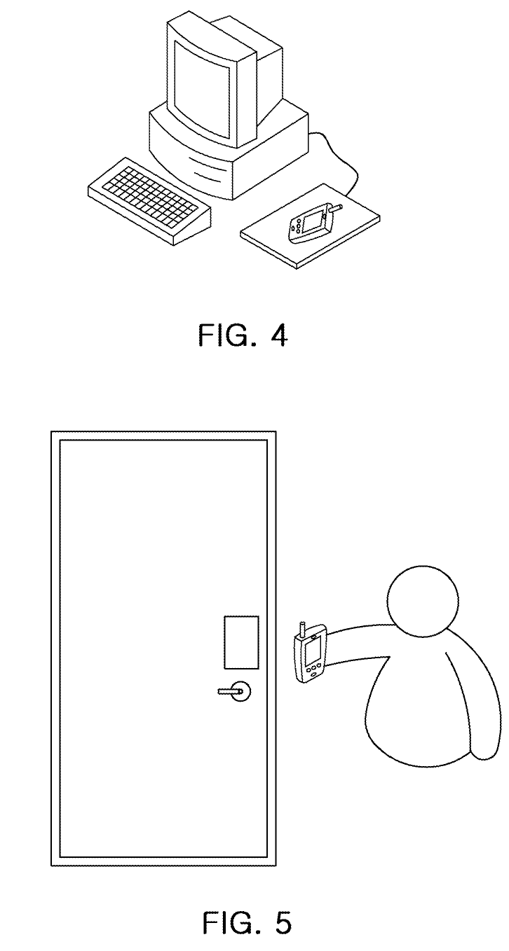

FIG. 4 is a view for explaining a service using a communications device using a near field by employing an external communications unit according to a wired communications scheme according to an exemplary embodiment of the present invention.

With reference to FIG. 4, among the services using the communications device using a near field, a service using an external communications unit according to a wired communications scheme may be provided such that when the near field communications device in the form of a pad is connected to a personal computer (PC) through a USB and the mobile device having the near field communications device is in contact or present in close proximity, the user may use the mobile phone as an external storage device, and the near field communications technique can be easily applied to the device having a USB host function.

The service of using the external communications unit according to the wired communications scheme can provide a new service through NFC by connecting the external communications unit to a device such as a TV or a DIVX player having a host function.

In modern society, almost every individual owns a mobile terminal having a communications function and additionally carries around a portable storage device. The mobile terminal held by an individual may be in contact with a connected computer so as to form a network to perform an operation, or may move to a different place for a conference in which the individual may bring the mobile terminal into contact with a beam projector to connect the beam projector as an external image device to the mobile phone to utilize image data of the mobile phone.

FIG. 5 is a view for explaining a service using a communications device using a near field by employing an external communications unit according to a wireless communications scheme according to an exemplary embodiment of the present invention.

With reference to FIG. 5, among the services using the communications device using a near field, a service using an external communications unit according to a wireless communications scheme may be provided such that the NFC is applied to the user's mobile terminal, and the user's mobile terminal may be brought into contact or into close proximity with an NFC device of a door. Namely, the service using an external communications unit according to a wireless communications scheme may be used as a service of a system allowing for entrance and exit through a user authentication.

The user may input an encryption key through a keypad of the user terminal or an encryption key applied to the door while viewing a display device of the contacted mobile terminal. This function may be also utilized for a payment service. In addition, the function may be also used in association with the user terminal or a fingerprint recognition system of the door.

As set forth above, the communications device using a near field according to exemplary embodiments of the invention can overcome a low data transfer rate of the related art near field communications. Namely, various services can be provided by using a high data transfer rate. In particular, near field communications and a network configuration and data communications performed through the existing wireless network can be implemented as a single combined technique. In addition, power supply and communications can be simultaneously provided effectively by sharing an interface of an electrical coupling and a magnetic coupling.

While the present invention has been shown and described in connection with the exemplary embodiments, it will be apparent to those skilled in the art that modifications and variations can be made without departing from the spirit and scope of the invention as defined by the appended claims.

What is claimed is:

1. A communications device using a near field, the device comprising:
a near field signal providing unit providing one of a baseband signal and a signal obtained by applying digital modulation to the baseband signal, as a near field signal;
an interface unit transmitting and receiving the provided near field signal; and
a controller controlling the near field signal providing unit and the interface unit.

2. The device of claim 1, wherein the near field signal providing unit does not apply a modulation scheme using a carrier to one of the baseband signal and the signal obtained by applying digital modulation to the baseband signal.

3. The device of claim 1, wherein the near field signal providing unit comprises a filter for limiting the frequency band of one of the baseband signal and the signal obtained by applying digital modulation to the baseband signal.

4. The device of claim 1, wherein the interface unit may include: an antenna transmitting and receiving a radio signal therethrough and a matching circuit.

5. The device of claim 4, wherein the interface unit further comprises an insulating layer protecting at least one of the antenna and the matching circuit.

6. The device of claim 4, wherein the interface unit is formed as a transparent electrode.

7. The device of claim 1, further comprises a display unit visually displaying information regarding the communications device using a near field.

8. The device of claim 7, wherein the display unit may visually display an external device available for communications.

9. The device of claim 7, wherein the display unit shares a component with the interface unit.

10. The device of claim 1, further comprising:
an external communications unit providing a communications scheme other than communications using a near field.

11. The device of claim 10, wherein the external communications unit uses one of a wired communications scheme and a wireless communications scheme.

12. The device of claim 11, wherein the wired communications scheme of the external communications unit is at least one of a USB, a LAN, and serial communications.

13. The device of claim 11, wherein the wireless communications scheme of the external communications unit is at least one of a WLAN, ZigBee™, RFID, and Bluetooth™.

14. The device of claim 1, further comprising:
an induced voltage generation unit supplying power required for the communications device using a near field.

15. The device of claim 14, wherein the induced voltage generation unit receives power from an external power source device and provides an induced voltage to a different communications device using a near field.

16. The device of claim 14, wherein the induced voltage generation unit receives an induced voltage from a different communications device using a near field.

17. The device of claim 1, further comprising:
a battery unit storing power required for the communications device using the near field.

18. The device of claim 1, wherein the controller comprises a memory for storing control information regarding the near field signal providing unit and the interface unit.

19. The device of claim 1, wherein the controller performs authentication for communications using the near field.
